(19) United States
(12) Patent Application Publication
(10) Pub. No.: US 2024/0289902 A1
(43) Pub. Date: Aug. 29, 2024

(54) DEVICES, METHODS AND SYSTEMS OF BLOCKCHAIN APPLICATIONS COMPLETING REAL ESTATE TRANSACTIONS

(71) Applicant: Chad Amon, Godley, TX (US)

(72) Inventor: Chad Amon, Godley, TX (US)

(21) Appl. No.: 18/430,580

(22) Filed: Feb. 1, 2024

Related U.S. Application Data
(60) Provisional application No. 63/486,573, filed on Feb. 23, 2023.
(60) Provisional application No. 63/506,477, filed on Jun. 6, 2023.

(51) Int. Cl. G06Q 50/16; H04L 9/32

(52) U.S. Cl. CPC G06Q 50/16; H04L 9/3218; G06Q 2220/00

(57) ABSTRACT

A device, method, and or system involving the integration of blockchain technology and real estate transactions. The present invention also pertains to a novel system and method for facilitating secure and efficient real estate transactions utilizing blockchain technology. Traditional real estate transactions often encounter challenges related to transparency, security, and inefficiency, leading to delays, disputes, and increased costs. The proposed solution leverages blockchain technology to streamline the real estate transaction process, mitigate fraud, and enhance trust among stakeholders. The system utilizes a decentralized blockchain ledger to record and authenticate real estate transactions, including property transfers, title deeds, and ownership records. Each transaction is securely timestamped, encrypted, and stored on the blockchain, ensuring immutability and transparency throughout the transaction lifecycle.

### CROSS-REFERENCE

This application claims priority from the U.S. patent application with Ser. No. 63/482,738, entitled, “Pre-Listing Home Buying and Selling Blockchain Platform” filed on Feb. 1, 2023, the U.S. patent application with Ser. No. 63/486,573, entitled, “C2C Pre-Listing Home Buying and Selling Zero-Knowledge Proof Blockchain Platform with an End-to-End Seamless Experience” filed on Feb. 23, 2023, and the U.S. patent application with Ser. No. 63/506,477, entitled, “A Web 3.0 C2C End to End Seamless Home Selling and Buying Experience blockchain platform where homeowners can claim their property and potentially earn Royalties in Perpetuity on the “Blockchain of Title” for the Current and Future Home Sale Transactions” filed on Jun. 6, 2023, all of which are incorporated herein by reference in their entireties.

### TECHNICAL FIELD

The present invention relates generally to the technical field of computer implemented technologies. More specifically, the present invention is a method for software assisting in both the process of buying and selling real estate.

### BACKGROUND

In recent years, blockchain technology has emerged as a groundbreaking innovation, disrupting traditional methods of data management and transaction processing. Originally devised as the underlying technology for Bitcoin, blockchain has transcended its cryptocurrency roots to become a transformative force across various industries.

Unlike centralized systems where authority is concentrated in a single entity, blockchain operates on a peer-to-peer network, empowering participants with equal control and ownership rights. This decentralized structure mitigates the risk of single points of failure and eliminates the need for intermediaries, thereby enhancing transparency and resilience.

Once recorded, data stored on the blockchain cannot be altered or tampered with retroactively. The cryptographic hash function ensures that any attempt to modify a block would necessitate altering all subsequent blocks, rendering it computationally infeasible and economically unviable. This feature engenders trust and accountability in transactions, fostering a reliable ecosystem for conducting business.

Blockchain employs cryptographic techniques to secure transactions and validate the integrity of data. Consensus mechanisms such as Proof of Work (“PoW”) or Proof of Stake (“PoS”) validate transactions, thwarting malicious actors and ensuring the integrity of the network. Additionally, data encryption techniques safeguard sensitive information, bolstering privacy and confidentiality.

Every transaction recorded on the blockchain is transparent and traceable, enabling stakeholders to track the origin, ownership, and movement of assets in real-time. This transparency fosters accountability and auditability, curbing fraudulent activities and enhancing regulatory compliance.

Blockchain technology has revolutionized the financial services industry by facilitating faster, more secure, and cost-effective transactions. Cryptocurrencies like Bitcoin and Ethereum have emerged as viable alternatives to traditional fiat currencies, enabling borderless payments and financial inclusion for underserved populations. Additionally, blockchain-powered smart contracts automate and execute contractual agreements, streamlining processes and reducing operational overheads.

Blockchain offers a secure and decentralized framework for identity management, enabling individuals to assert ownership and control over their digital identities. By leveraging blockchain technology, governments and enterprises can mitigate identity theft, streamline identity verification processes, and provide individuals with secure access to services and resources, thereby fostering trust and inclusivity in the digital economy.

The present invention is software for “all things real estate” Layer-1 blockchain where a homeowner can claim their property on the blockchain to potentially earn in perpetuity transactions on the chain of title. At the core, it's entity matching on the blockchain where a property owner's ID is connected to a claimed property. From the Layer-1 blockchain, other dapps can be built on top of the Dataholm blockchain for web 3.0 applications such as titling, real estate transactions, financing, api-like photo sharing, or any services related to real estate.

### SUMMARY

Aspects and advantages of the invention will be set forth in part in the following description, or may be obvious from the description, or may be learned through practice of the invention.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the system further comprises a zero-knowledge proof for validation.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the system further comprises a zero-knowledge proof for validation where homeowners can claim their property and potentially earn royalties in perpetuity.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the consensus mechanism is Proof of Work (“PoW”) consensus mechanism.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the consensus mechanism is Practical Byzantine Fault Tolerance (“PBFT”) consensus mechanism.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the consensus mechanism is Proof of Stake (“PoS”) consensus mechanism.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of Merkle Trees.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of a token.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of a token, wherein the token is designed in a NFT-like multi faceted manner wherein the homeowner can claim a property with other added benefits tied to each unique token with specific data using the same address.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of a token design to facilitate tilting procedures of a real estate transaction.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of a token design to facilitate fractional ownership management and transactions of real estate.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, further comprising of a token design to facilitate renting and related management procedures regarding commercial or residential real estate.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the system is designed to allow pre-sale of the homes without use of the MLS.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein the system provides an incentives Owner mode wherein the owner can contract a realtor at a discounted rate.

In some embodiments the invention includes a system for completing real estate transactions comprising of a block chain wherein the block chain comprises of a series of blocks, wherein each block containing a bundle of transactions and the blocks are linked together in chronological order, forming a continuous chain, a cryptographic hash function wherein the cryptographic hash function is used to create a unique identifier for each block, one or more consensus mechanism wherein the consensus mechanism is a protocol that ensures all participants in the network agree on the validity of transactions and the order of blocks in the blockchain, a peer-to-peer network consists of interconnected nodes that communicate and share data without a central authority, block chain protocol wherein the block chain protocol defines the rules and standards that govern the operation of the blockchain, wherein users of the system collect residuals as sales transaction continue on the platform.

### DETAILED DESCRIPTION

Reference now will be made in detail to the embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a further embodiment. Thus, it is intended that the present invention covers such modifications and variations as come within the scope of the appended claims and their equivalents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

In accordance with the present invention, a disclosure is made of a device, method and system that incorporates several fields of entertainment in a novel and unique manner. This device, method, or system 10 generally consists of a unique block chain protocol designed for real estate transactions. In some device, method, or system 10 is designed to complete all types of real estate transactions and/or record keeping wherein the device, method or system 10 includes a block chain blockchain wherein the block chain comprises of a series of blocks, wherein each block containing a bundle of transactions and the blocks are linked together in chronological order, forming a continuous chain; a cryptographic hash function wherein the cryptographic hash function is used to create a unique identifier for each block; one or more consensus mechanism(s) wherein the consensus mechanism(s) is a protocol that ensures all participants in the network agree on the validity of transactions and the order of blocks in the blockchain; a peer-to-peer network consists of interconnected nodes that communicate and share data without a central authority; and a block chain protocol wherein the block chain protocol defines the rules and standards that govern the operation of the blockchain network. In some embodiments the device, method, or system 10 further includes a token. In some embodiments the device, method, or system 10 further includes a token, wherein the token 20 is designed in a NFT-like multi faceted manner wherein the homeowner can claim a property with other added benefits tied to each unique token with specific data using the same address.

In some embodiments the token 20 is designed to facilitate the sale of residential real estate. In some embodiments the token 20 is designed to facilitate the sale of commercial real estate homes. In some embodiments the token 20 is designed to facilitate all aspect of the selling portion of a real estate transaction. In some embodiments, the token 20 is designed to facilitate all aspects of the buying portion of a real estate transaction. In some embodiments the token 20 is designed to facilitate all aspects of the financing of a real estate transaction. In some embodiments the token 20 is designed to facilitate all aspects of titling real estate whether or not during a real estate transaction. In some embodiments the token 20 is designed to facilitate all aspects of providing insurance to real estate whether or not for a particular transaction. In some embodiments the token 20 is designed to facilitate all aspects of investing in real estate whether commercial or residential or mixed. In some embodiments the token 20 is designed to facilitate all aspects of fractional ownership of real estate and related transactions. In some embodiments the token 20 is designed to facilitate all aspects of the renting real estate or a rental transaction.

In some embodiments the blockchain protocol is a layer 1 native blockchain with a multifaceted coin. In some embodiments the multifaceted coin is designed for every application of real estate including, but not limited to, creating a 3.0 marketplace of dapps that includes residential and commercial home selling, buying, financing, titling, insurance, investing, fractional ownership, and renting. In some embodiments a single property can have multiple tokens, wherein the multiple tokens share the same address. In one non-limiting example, the device, method or system can have one token that records title, another token addresses mortgage, another token is designed for insurance.

In some embodiments of the invention, the invention includes a web 3.0 C2C End to end seamless home selling and buying experience blockchain platform utilizing a zero-knowledge proof for validation where homeowners can claim their property and potentially earn royalties in perpetuity on the “Blockchain of Title” for the current and future home sale transactions. In some embodiments of the invention property buyers, property sellers, realtors and brokers all earn on the block chain. In some embodiments additional stakeholders are rewarded or incentivized with rewards from “pay to play” vendors and participating retail partners that use a browser extension, plug-in, api or the company website.

In some embodiments the device, method, and system includes one or more rewards programs. In some embodiments the device, method, and system includes one or more rewards programs wherein consumers earn rewards, however not as cash but in the form of a token. In some embodiments the device, method, and system includes one or more rewards programs wherein consumers earn rewards, however not as cash but in the form of a token wherein the token is paid by selected retail partners which the consumer can use with their crypto wallet much like a credit or reward card for other retail discounts and purchases.

In some embodiments, the device, method, and system includes an end to end seamless home selling and buying web platform. In some embodiments, the device, method, and system includes an end to end seamless home selling and buying web platform with a social media like user experience. In some embodiments, the device, method, and system includes an end to end seamless home selling and buying web platform with a social media like user experience for buyers and/or sellers and/or realtors. In some embodiments, the device, method, and system includes an end to end seamless home selling and buying web platform with a social media like user experience for buyers and/or sellers and/or realtors, wherein the embodiment further includes a step by step guide using a zero-knowledge protocol which validates from the buyers and sellers in order to complete the sale.

A zero-knowledge protocol for blockchain represents an advanced cryptographic technique that allows one party (the prover) to prove to another party (the verifier) the validity of a statement without revealing any additional information beyond the fact that the statement is true. In the context of blockchain, zero-knowledge proofs enable users to authenticate transactions or data without disclosing sensitive information such as the contents of the transaction or the private keys involved. Through zero-knowledge protocols, blockchain systems can achieve enhanced privacy, confidentiality, and security, while still maintaining transparency and verifiability. Zero-knowledge proofs are particularly valuable in scenarios where privacy and data confidentiality are paramount, such as financial transactions, identity verification, and supply chain management. In embodiments including a zero-knowledge proof, the zero-knowledge proof creates a “plug and pay” experience as the platform makes the transactions more transparent with instant verification through the blockchain.

In some embodiments the invention incorporates both zero-knowledge proof and Artificial Intelligence for efficiency applications in a manner that creates a “plug and pay” experience. In some embodiments the invention incorporates both zero-knowledge proof and Artificial Intelligence for efficiency applications in a manner that creates a “plug and pay” experience wherein the platform is specifically designed to make the transactions more transparent with instant verification through the blockchain. In embodiments of the invention, the seller and/or the buyer complete the steps in completing the home sale, each on their own end, which fulfills step by step each stakeholder's specific requirements that are necessary in completing the real estate transaction wherein the zero-knowledge proof is utilized to ensure that their obligations are finalized and validated.

In some embodiments the invention will include a hybrid platform for homebuyers, sellers, and for realtors wherein a self-service option is provided to a homeowner user wherein the homeowner user can pre-list as a for sale by owner and not on the multiple listing service (“MLS”).

In some embodiments the invention allows a user to contract a realtor at a discounted rate through a realtor auction, where realtors market and auction themselves to the seller or buyer, offering to charge a smaller percentage fee or a flat fee for seller, buyer, or dual representation. In embodiments incorporating rewards, the reward real estate and marketplace platform empowers all users of the platform to earn tokens on numerous real estate transactions to use for retail and vendor partner discounts through the blockchain, zero proof protocols, and artificial intelligence, thus ultimately optimizing and potentially replacing the current MLS, but at a minimum allows consumers to earn and lessen the high cost of real estate transactions.

In some embodiments the invention can be described as a C2C Pre-Listing Platform with an end to end seamless home selling and buying experience using zero-knowledge proof blockchain for validation, NFT-like incentives to earn tokens and potential royalties in perpetuity on the “Blockchain of Title” for the current and future home sale transactions, and tokens for transactions with partners.

Blocks are fundamental units within a blockchain network, encapsulating data, transactions, and metadata integral to the system's operation. In some embodiments the blockchain network follows a standard block structure. In some embodiments blocks are used primarily for recording transactional data and maintaining its cryptocurrency ledger. In some embodiments the blocks support the execution of smart contracts within blocks, enabling the creation of decentralized applications (“DApps”) and automated agreements. The size of the blocks vary depending on the embodiment of the invention. In embodiments with larger blocks, each block contains more transactions.

The invention also includes an immutable ledger. The immutable ledger serves by providing an indelible record of all transactions and data stored on the network. The primary purpose of an immutable ledger is to ensure that once a transaction is recorded and confirmed within a block, it becomes virtually impossible to alter or tamper with retroactively. This immutability is achieved through cryptographic hashing techniques that link each block to its predecessor, creating a continuous and unbroken chain of transactional history. The immutable ledger fosters trust among participants by providing a verifiable and transparent record of all transactions, enabling stakeholders to audit and verify the authenticity and integrity of data without relying on centralized authorities or intermediaries. Additionally, the immutable ledger enhances security by mitigating the risk of fraudulent activities, double-spending, and unauthorized modifications, thereby establishing a reliable foundation for conducting secure and trustworthy transactions within the blockchain ecosystem.

In some embodiments, the invention includes Merkle Trees. Merkle Trees are cryptographic data structures used to efficiently summarize and verify the integrity of transactions within a block. By hashing transaction data in a hierarchical manner, Merkle trees enable quick validation of block contents while minimizing the computational overhead required for verification. This feature enhances the efficiency and security of blockchain networks, particularly in scenarios with a high volume of transactions.

The genesis block represents the initial block in a blockchain network, serving as the foundation upon which subsequent blocks are built. It establishes the starting point for the blockchain's ledger and contains unique characteristics distinguishing it from subsequent blocks, such as lacking a reference to a previous block. In some embodiments the genesis block has unique features.

Block propagation refers to the process of disseminating newly mined blocks across the network to ensure consistency and synchronization among nodes. Consensus mechanisms such as Proof of Work (“PoW”) or Proof of Stake (“PoS”) or Practical Byzantine Fault Tolerance (“PBFT”) govern the validation and acceptance of blocks, requiring network participants to expend computational resources or stake tokens to participate in the consensus process. In some embodiments the device, method, or system includes a consensus mechanism.

In some embodiments the invention will include a proof of work or PoW, consensus mechanism. In PoW, network participants compete to solve complex mathematical puzzles by expending computational resources. The puzzle-solving process involves repeatedly hashing the block's contents until a hash with a specific pattern, known as the target, is generated. The first network participant to solve the puzzle broadcasts the solution to the network, and other nodes verify the validity of the solution before accepting the new block. PoW ensures the security and integrity of the blockchain by making it computationally expensive to tamper with transaction history. Additionally, PoW mitigates the risk of double-spending attacks and maintains a decentralized network by distributing authority among network participants.

In some embodiments the invention will include a proof of stake or PoS, consensus mechanism. In PoS, the mechanism operates by selecting block validators based on the amount of cryptocurrency they hold and are willing to “stake” as collateral. In embodiments with PoS, the validators are chosen to create new blocks and validate transactions based on their stake in the network, with higher stakes typically resulting in increased chances of being chosen as a validator. In some embodiments with PoS, the mechanism is set up so that validators risk losing their staked cryptocurrency if they act dishonestly. In some embodiments with PoS, the PoS network implements one or more of the following mechanisms; (1) slashing penalties (2) longer validation times.

In some embodiments the invention will include a Practical Byzantine Fault Tolerance or PBFT consensus mechanism. The PBFT consensus algorithm is designed to achieve consensus among nodes in a distributed system, even in the presence of Byzantine faults, where some nodes may behave maliciously or fail unpredictably. PBFT operates based on a series of message exchanges among nodes, with each node taking turns as the primary or leader for a specific round of consensus. During each round, the primary node proposes a new block of transactions, and other nodes in the network validate the proposed block through a multi-step process. Nodes exchange messages to pre-prepare, prepare, and commit the proposed block, ensuring that all honest nodes agree on the validity of the block before it is committed to the blockchain. By tolerating up to one-third of faulty nodes in the network, PBFT achieves Byzantine fault tolerance and ensures the integrity and consistency of the distributed ledger.

In some embodiments the device, method or system includes private and/or public keys. Public and private keys are cryptographic keys used to secure transactions and provide access to digital assets.

Soft “pre” listing of residential homes for homeowners to list without the MLS and without a realtor on an end-to-end seamless home buying and selling blockchain Dataholm™ platform, that offers “incentivized” ownership on the transaction in the form of tokens. The property will be listed on the blockchain with a social media like user experience for buyers and sellers. By “pre” listing, the For Sale By “Incentivized” Owner, can either list and sell with a step-by-step guide or contract a realtor at a discounted rate through a realtor auction, where realtors can market themselves to the seller, offering to charge a smaller percentage fee or a flat fee for seller representation.

Either way, if the seller sells without a realtor or with, like NFTs once a homeowner is on the Dataholm™ blockchain, with the “pre” listing they will collect potential residuals as long as sales transactions are on the platform, giving indefinite transactional ownership to both sellers and future buyers.

A C2C soft “pocket listing” of residential homes for homeowners to pre-list without a realtor and not on the MLS, but on an end to end seamless home buying and selling blockchain platform with a social media like user experience for both buyers, sellers and realtors that includes a step by step guide using a zero-knowledge protocol which validates from all parties to complete the sale.

Although the invention has been explained in relation to its preferred embodiment, it is to be understood that many other possible modifications and variations can be made without departing from the spirit and scope of the invention

The invention can be applied in other industries as well. The invention has specific and effective applications in the industries of real property transactions and similar transactions.

What is claimed is:

1. A system for completing real estate transactions comprising of
a block chain wherein the block chain comprises of a series of blocks, wherein each block containing a bundle of transactions and the blocks are linked together in chronological order, forming a continuous chain
A cryptographic hash function wherein the cryptographic hash function is used to create a unique identifier for each block;
one or more consensus mechanism wherein the consensus mechanism is a protocol that ensures all participants in the network agree on the validity of transactions and the order of blocks in the blockchain
a peer-to-peer network consists of interconnected nodes that communicate and share data without a central authority
block chain protocol wherein the block chain protocol defines the rules and standards that govern the operation of the blockchain network

2. The system in claim 1, wherein the system further comprises a zero-knowledge proof for validation.

3. The system of claim 1, wherein the system further comprises a zero-knowledge proof for validation where homeowners can claim their property and potentially earn royalties in perpetuity.

4. The system of claim 1, wherein the consensus mechanism is Proof of Work (“PoW”) consensus mechanism.

5. The system of claim 1, wherein the consensus mechanism is Practical Byzantine Fault Tolerance (“PBFT”) consensus mechanism.

6. The system of claim 1, wherein the consensus mechanism is Proof of Stake (“PoS”) consensus mechanism.

7. The system of claim 1, further comprising of Merkle Trees.

8. The system of claim 1, further comprising of a token.

9. The system of claim 1, further comprising of a token, wherein the token is designed in a NFT-like multi faceted manner wherein the homeowner can claim a property with other added benefits tied to each unique token with specific data using the same address.

10. The system of claim 1, further comprising of a token design to facilitate tilting procedures of a real estate transaction.

11. The system of claim 1, further comprising of a token design to facilitate fractional ownership management and transactions of real estate.

12. The system of claim 1, further comprising of a token design to facilitate renting and related management procedures regarding commercial or residential real estate.

13. The system of claim 1, wherein the system is designed to allow pre-sale of the homes without use of the MLS.

14. The system of claim 1, wherein the system provides an incentives Owner mode wherein the owner can contract a realtor at a discounted rate.

15. The system of claim 1, wherein users of the system collect residuals as sales transaction continue on the platform.
